(19) United States
(12) Patent Application Publication
(10) Pub. No.: US 2026/0105014 A1
(43) Pub. Date: Apr. 16, 2026

(54) Interrupt Processing Method and Apparatus, Server, Electronic Device, and Non-Volatile Readable Storage Medium

(71) Applicant: SUZHOU METABRAIN INTELLIGENT TECHNOLOGY CO., LTD., Suzhou, Jiangsu (CN)

(72) Inventors: Luxiang WANG, Suzhou, Jiangsu (CN); Xiao WANG, Suzhou, Jiangsu (CN); Fei LU, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/115,744

(22) PCT Filed: Dec. 20, 2023
(86) PCT No.: PCT/CN2023/140401

§ 371 Date: Mar. 26, 2025

(30) Foreign Application Priority Data
Mar. 7, 2023 (CN) 202310208627.5

(51) Int. Cl. G06F 13/26

(52) U.S. Cl. CPC G06F 13/26

(57) ABSTRACT

The present disclosure provides an interrupt processing method and apparatus, a server, an electronic device, and a non-volatile readable storage medium, and relates to the technical field of services. The interrupt processing method includes: receiving interrupt requests (IRQs) sent by external devices, and sending the IRQs to a Platform Controller Hub (PCH) based on preset control logic, where the preset control logic is used for controlling that interrupt numbers of the IRQs received by the PCH do not conflict. Therefore, the preset control logic of a Complex Programmable Logic Device (CPLD) realizes that the IRQs do not conflict.

### CROSS-REFERENCE TO RELATED APPLICATION

The present disclosure claims priority to Chinese Patent Application No. 202310208627.5, filed in the China National Intellectual Property Administration (CNIPA) on Mar. 7, 2023 and entitled “Interrupt Processing Method and Apparatus, Server, Electronic Device, and Storage Medium”, which is incorporated herein by reference in its entirety.

### TECHNICAL FIELD

The present disclosure relates to the technical field of servers, and in particular, to an interrupt processing method and apparatus, a server, an electronic device, and a non-volatile readable storage medium.

### BACKGROUND

With the improvement of server functions, more and more devices are configured on a server. In a system of each server, interrupt control of each device in the system is controlled by an interrupt controller 8259 or other devices. At present, there are 16 groups of Interrupt Requests (IRQs) in total. Actually, only 15 groups of IRQs are available for the device to invoke after a group of IRQs used for bridging is removed. In practice, many groups of IRQs have already been pre-assigned to exemplary hardware, so the number of IRQs available for an external device is limited.

In general, different types of external devices are prevented from occupying the same IRQ signal when the IRQ is configured, so as to prevent a problem of an IRQ conflict. However, when an IRQ type sent by the external device to a Platform Controller Hub (PCH) through a Low Pin Count (LPC) is the IRQ, and the two external devices are configured with the same interrupt number, the two external devices may not work normally.

For problems such as the IRQ conflict in a related art, an effective solution has not been proposed.

### SUMMARY

In view of problems in a related art, the present disclosure provides an interrupt processing method and apparatus, a server, an electronic device, and a non-volatile readable storage medium.

According to a first aspect, the present disclosure further provides an interrupt processing method, including the following operation.

IRQs sent by external devices are received.

The IRQs are sent to a PCH based on preset control logic.

The preset control logic is used for controlling that interrupt numbers of the IRQs received by the PCH do not conflict.

According to the interrupt processing method provided in the present disclosure, the operation that the IRQs are sent to the PCH based on the preset control logic includes the following operations.

The interrupt numbers configured for the external devices are detected, and the external devices with the same interrupt number are determined as interrupt conflict external devices when the external devices with the same interrupt number are detected.

The interrupt numbers of the IRQs of the interrupt conflict external devices received by the PCH are adjusted based on the preset control logic when the IRQs sent by the interrupt conflict external devices are received.

According to the interrupt processing method provided in the present disclosure, the operation that the interrupt number of the IRQs of the interrupt conflict external devices received by the PCH are adjusted based on the preset control logic includes the following operations.

A first target external device of the interrupt conflict external devices and a target interrupt number matching the first target external device are determined, where priority of the target interrupt number is lower than priority of a current conflict interrupt number of the first target external device.

An Interrupt Request (IRQ) of the first target external device is sent to the PCH after waiting for a target clock, so as to adjust the interrupt number of the IRQ of the first target external device from the current conflict interrupt number to the target interrupt number.

The target clock is determined based on the target interrupt number and the current conflict interrupt number.

According to the interrupt processing method provided in the present disclosure, the operation that the IRQs are sent to the PCH based on the preset control logic includes the following operations.

An interrupt conflict external devices in the external devices is determined.

A first target external device of the interrupt conflict external devices and a target interrupt number matching the first target external device are determined, where priority of the target interrupt number is lower than priority of a current conflict interrupt number of the first target external device.

Interrupt numbers of the IRQ identified by the PCH are adjusted by adjusting the target clock when the IRQ of first target external device are sent to the PCH based on the preset control logic, so as to control that the interrupt numbers of the IRQ received by the PCH do not conflict.

According to the interrupt processing method provided in the present disclosure, the target clock is determined through the following formula:

$$Δ T = ( m - n ) T ;$$

where ΔT is the target clock, m is number value of the target interrupt number, n is a number value of current conflict interrupt number, and T is a unit clock cycle.

According to the interrupt processing method provided in the present disclosure, the operation that the first target external device of the interrupt conflict external devices and a target interrupt number matching the first target external device are determined includes the following operations.

when there are two interrupt conflict external devices, and there is at least one interrupt number in an idle state that meets a preset requirement, either of the interrupt conflict external devices is selected as the first target external device, and the target interrupt number matching the first target external device is determined from the interrupt number in the idle state.

The preset requirement is that priority of the interrupt number in the idle state is lower than priority of the current conflict interrupt number of the interrupt conflict external devices.

According to the interrupt processing method provided in the present disclosure, the operation that the target interrupt number matching the first target external device is determined from the interrupt number in the idle state includes the following operation.

The target interrupt number matching the first target external device is determined from the interrupt number in the idle state according to a preset proximity adjustment principle.

According to the interrupt processing method provided in the present disclosure, the operation that the first target external device of the interrupt conflict external devices and a target interrupt number matching the first target external device are determined includes the following operations.

Descending sorting is performed on the interrupt conflict external devices according to an importance score of the interrupt conflict external devices, and at least one target external device is selected from the interrupt conflict external devices according a descending sorting result when there are more than two interrupt conflict external devices, and there is at least one interrupt number in an idle state that meets a preset requirement.

The target interrupt number matching each first target external device is determined from interrupt number in the idle state.

The preset requirement is that priority of the interrupt number in the idle state is lower than the priority of the current conflict interrupt number of the interrupt conflict external devices.

According to the interrupt processing method provided in the present disclosure, the importance score is determined through the following formula:

$$Q = a * N + b * M ;$$

where Q is an importance score, N is a ranking of the interrupt conflict external devices after being subjected to the descending sorting according to the priority of the current conflict interrupt number, M is a ranking of the interrupt conflict external devices after being subjected to the descending sorting according to an operating frequency, and a and b are conventional coefficients.

According to the interrupt processing method provided in the present disclosure, after that the descending sorting is performed on the interrupt conflict external devices according to the importance score of the interrupt conflict external devices, the operation further includes the following operations.

At least one external device that needs to be disabled is selected from the interrupt conflict external devices according to the descending sorting result when a quantity of the interrupt numbers in the idle state that meets the preset requirement is less than a quantity of the interrupt conflict external devices that need to be subjected to interrupt number adjustment.

The quantity of the interrupt conflict external devices that need to be subjected to interrupt number adjustment is determined according to the quantity of the current conflict interrupt numbers and the quantity of the interrupt conflict external devices.

According to the processing method provided in the present disclosure, the quantity of the interrupt conflict external devices that need to be subjected to interrupt number adjustment is equal to a difference between the quantity of the interrupt conflict external devices and the quantity of the current conflict interrupt numbers.

According to the processing method provided in the present disclosure, the operation that at least one external device that needs to be disabled from the interrupt conflict external devices according to the descending sorting result includes the following operations.

The interrupt number of the device 2 and the interrupt number of the device 4 are determined to be unchanged, the device 1 and the device 5 are determined as first target external devices, and the device 3 is set to disable IRQ3 when the interrupt conflict external devices include a device 1, a device 2, a device 3, a device 4, and a device 5, the interrupt numbers of the device 1, the device 2, and the device 3 are all IRQ3, the interrupt numbers of the device 4 and the device 5 are both IRQ5, there are only two interrupt numbers in the idle state that meet the preset requirement, and the descending sorting result is that the device 2, the device 1, the device 3, the device 4, and the device 5.

According to the interrupt processing method provided in the present disclosure, the operation that the target interrupt number matching each first target external device is determined from the interrupt number in the idle state includes the following operation.

The target interrupt number matching each first target external device is determined from the interrupt number in the idle state according to a preset proximity adjustment principle.

According to the interrupt processing method provided in the present disclosure, the preset proximity adjustment principle is that a clock difference between the target interrupt number and the current conflict interrupt number is minimum.

The interrupt processing method provided in the present disclosure further includes the following operation.

An IRQ of a second target external device is sent to the PCH, where the second target external device is an external device other than the interrupt conflict external devices.

According to a second aspect, the present disclosure further provides an interrupt processing apparatus, including a receiving module and a logic module.

The receiving module is configured to receive IRQs sent by external devices.

The logic module is configured to send the IRQ to a PCH based on preset control logic.

The preset control logic is used for controlling that interrupt numbers of the IRQ received by the PCH do not conflict.

According to a third aspect, the present disclosure further provides a server. The server includes a PCH and a Complex Programmable Logic Device (CPLD). The PCH includes an interrupt input pin.

An input pin of the CPLD is connected to an interrupt output pin of an external device, and an output pin of the CPLD is connected to the interrupt input pin.

The CPLD implements any of the interrupt processing methods described above when executed.

According to the server provided in the present disclosure, the CPLD includes a plurality of pairs of input pins and output pins, and the PCH includes a plurality of interrupt input pins.

The interrupt output pin of each external device is connected to one of the interrupt input pins through one pair of input pin and output pin.

According to a fourth aspect, the present disclosure further provides an electronic device, including a memory, a processor, and a computer program stored on the memory and runnable on the processor. The processor implements any one of the interrupt processing methods described above when executing a program.

According to a fifth aspect, the present disclosure further provides a non-transient computer non-volatile readable storage medium, having a computer program stored therein. The computer program implements any one of the interrupt processing methods when executed by a processor.

According to the interrupt processing method and apparatus, the server, the electronic device, and the non-volatile readable storage medium provided in the present disclosure, IRQs sent by external devices are received, and the IRQs are sent to a PCH based on preset control logic, where the preset control logic is used for controlling that interrupt numbers of the IRQs received by the PCH do not conflict. Therefore, the preset control logic of a CPLD realizes that the IRQs do not conflict.

### BRIEF DESCRIPTION OF THE DRAWINGS

To describe technical solutions in embodiments of the present disclosure or in a related art more clearly, the following briefly introduces accompanying drawings for describing the embodiments or the related art. Apparently, the accompanying drawings in the following description show some embodiments of the present disclosure, and those of ordinary skill in the art may still derive other drawings from the accompanying drawings without creative efforts.

FIG. 1 is a schematic diagram of a connection between an external device and a PCH in a related art.

FIG. 2 is a schematic flowchart of an interrupt processing method according to the present disclosure.

FIG. 3 is a schematic diagram of a connection between an external device and a PCH device according to an embodiment of the present disclosure.

FIG. 4 is a schematic structural diagram of an electronic device according to the present disclosure.

### DETAILED DESCRIPTION OF THE EMBODIMENTS

To make objectives, technical solutions, and advantages of embodiments of the present disclosure clearer, the following clearly and completely describes the technical solutions in the embodiments of the present disclosure with reference to the accompanying drawings in the embodiments of the present disclosure. Apparently, the described embodiments are part rather than all of the embodiments of the present disclosure. Based on the embodiments in the present disclosure, all other embodiments obtained by those of ordinary skill in the art without creative work fall within the scope of protection of the present disclosure.

A Low Pin Count (LPC) bus is configured to connect a low speed device and an “old” device to a Central Processing Unit (CPU) in a compatible machine. A common low speed device includes a Basic Input Output System (BIOS), a serial port, a parallel port, and a keyboard, a mouse, a floppy disk controller, and the like of a Personal System 2 (PS/2). The LPC is usually physically connected to a PCH on a mainboard. The PCH is usually connected to a low speed device, a series of “old” devices, other external devices, and the like, for example, a CPLD.

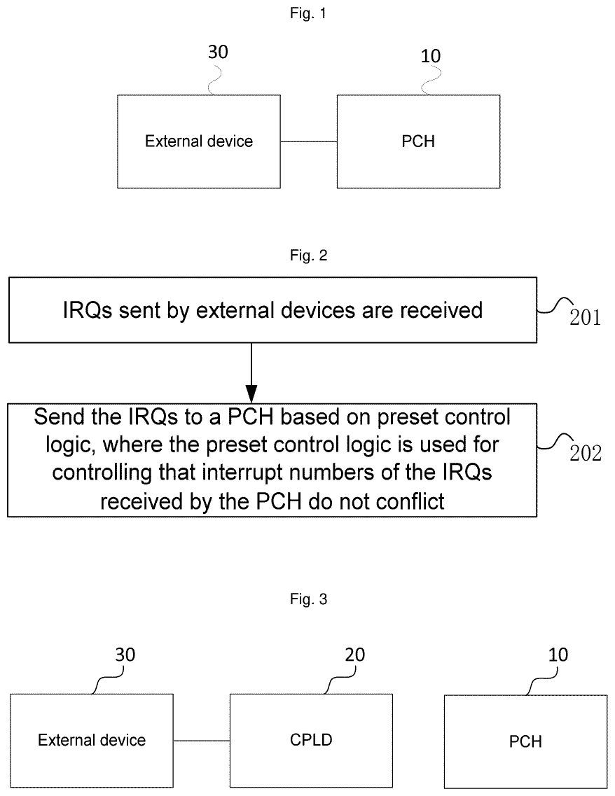

In a related art, as shown in FIG. 1, an interrupt output pin of an external device 30 is connected to an interrupt input pin of a PCH 10 through an LPC bus. The PCH 10 assigns an interrupt number (that is, an IRQ number) for an Interrupt Request (IRQ) of the external device 30 according to a number of a pin. The PCH assigns corresponding working time to each external device according to the interrupt number for the external device 30 to work, so that the external devices 30 have different interrupt numbers, and clocks corresponding to the IRQs of various external devices 30 in interrupt signal waveforms received by the PCH 10 are different, for example, the interrupt number in a device 1 is 5, and the interrupt number in a device 3 is 10, then the IRQ of the device 1 is transmitted to the PCH 10 at a fifth clock, and the IRQ of the device 3 is transmitted to the PCH 10 at a tenth clock. Therefore, when there are two external devices 30 configured with the same interrupt number, the IRQs of the two external devices 30 are transmitted to the PCH 10 at the same clock, the PCH 10 may not identify which external device 30 that the IRQ belongs to and may not respond correspondingly, and then the two external devices 30 may not work normally.

Therefore, to solve the above problems, an embodiment of the present disclosure provides an interrupt processing method, applied to a CPLD. Therefore, preset control logic of the CPLD realizes that IRQs do not conflict.

FIG. 2 is a schematic flowchart of an interrupt processing method according to an embodiment of the present disclosure, as shown in FIG. 2, including the following operations.

At S201: IRQs sent by external devices are received.

In this embodiment, an interrupt output pin of the external device is connected to an input pin of a CPLD, and an output pin of the CPLD, is connected to an interrupt input pin of a PCH. The IRQs of the external devices are received by the CPLD, so that the CPLD, may solve an interrupt conflict when the external devices have an interrupt conflict.

At S202: The IRQs are sent to a PCH based on preset control logic, where the preset control logic is used for controlling that interrupt numbers of the IRQs received by the PCH do not conflict.

It may be understood that the CPLD 20 is a digital integrated circuit that allows a user to construct logic functions according to respective requirements, which is mainly formed by a logic block, a programmable interconnect channel, and an Input/Output block (I/O block). Usually, one logic block includes 4 to 20 macrocells. Each macrocell is generally formed by a product term array, product term distribution, and a programmable register. Each macrocell has a plurality of configuration manners, and the macrocells may be cascaded for use. Therefore, complex combinatorial logic and temporal logic may be realized. The programmable interconnect channel mainly provides an interconnection network between the logic block, the microcell, and the input/output pin. The IO block provides an interface between internal logic and an I/O pin of a device.

In this embodiment, the interrupt output pin of the external device is connected to the input pin of the CPLD, the output pin of the CPLD is connected to the interrupt input pin of the PCH, the PCH assigns interrupt numbers for the IRQs of the external devices according to the numbers of the pins, and the IRQs of the external devices are transmitted to the CPLD at clocks corresponding to the interrupt numbers assigned to the IRQs of the external devices, and are transmitted to the PCH through the CPLD.

In this embodiment, the IRQ between the external device and the PCH is transmitted through the CPLD. The CPLD has a temporal logic function, so that a clock when the IRQ is transmitted to the PCH may be adjusted according to preset control logic configured in the CPLD, so as to adjust the interrupt number of the IRQ identified by the PCH.

According to the interrupt processing method provided in an embodiment of the present disclosure, IRQs sent by external devices are received, and the IRQs are sent to a PCH based on preset control logic, where the preset control logic is used for controlling that interrupt numbers of the IRQs received by the PCH do not conflict. Therefore, the preset control logic of a CPLD realizes that the IRQs do not conflict.

On the basis of the above embodiments, an operation that the IRQs are sent to the PCH based on the preset control logic include the following operations.

The interrupt numbers configured for a plurality of external devices are detected, and the external devices with the same interrupt number are determined as interrupt conflict external devices when the external devices with the same interrupt number are detected.

The interrupt numbers of the IRQs of the interrupt conflict external devices received by the PCH are adjusted based on the preset control logic.

In this embodiment, the PCH distinguishes the clock at which the IRQ is transmitted to identify the interrupt number corresponding to the IRQ, and then identifies a corresponding external device according to the interrupt number. Therefore, processing stages performed by the CPLD on the transmitted IRQs of the external devices are divided into two stages.

In a first stage: comparison detection is performed on the interrupt numbers configured for the plurality of connected external devices first. The external devices with the same interrupt number are marked as interrupt conflict external devices when the external devices with the same interrupt number are detected. For example, currently connected devices include a device 1, a device 2, a device 3, and a device 4. An interrupt number of the device 1 is IRQ5, an interrupt number of the device 2 is IRQ7, and interrupt numbers of the device 3 and the device 4 are IRQ10, then the device 3 and the device 4 are marked as the interrupt conflict external devices.

In a second stage: in a startup and operation working stage, when the CPLD adjusts a clock when the IRQs are sent to the PCH according to preset control logic to adjust the interrupt numbers of the IRQs identified by the PCH when the IRQs of the marked interrupt conflict external devices are received.

In an example, when there are two external devices configured with the same interrupt number, the CPLD immediately outputs an IRQ of one of the external devices to the PCH first after receiving the IRQs of the two external devices, and outputs the IRQ to the PCH after controlling the other IRQ to wait for a clock, so as to change that the PCH receive the IRQs of the two external devices at different clocks, and the PCH identifies different interrupt numbers, so that the two external devices may work normally.

On the basis of the above embodiments, the method further includes the following operation.

An IRQ of a second target external device is sent to the PCH, where the second target external device is an external device other than the interrupt conflict external devices.

In this embodiment, when the interrupt numbers of the external devices do not conflict, a CPLD immediately outputs an IRQ to the PCH when the IRQs of the external devices with the interrupt numbers that do not conflict are received to ensure that the IRQ is transmitted to the PCH at a corresponding clock, so that the PCH identifies the external device corresponding to the IRQ.

On the basis of the above embodiments, the operation that the interrupt numbers of the IRQs of the interrupt conflict external devices received by the PCH are adjusted based on the preset control logic includes the following operations.

A first target external device of the interrupt conflict external devices and a target interrupt number matching the first target external device are determined, where priority of the target interrupt number is lower than priority of a current conflict interrupt number of the first target external device.

An IRQ of the first target external device is sent to the PCH after waiting for a target clock, so as to adjust the interrupt number of the IRQ of the first target external device from the current conflict interrupt number to the target interrupt number.

The target clock is determined based on the target interrupt number and the current conflict interrupt number.

It is easily understood that it needs to control that one interrupt number may only be occupied by one external device at most to solve an interrupt conflict. For example, when the device 1 and the device 2 occupy the same interrupt number, the interrupt number of the device 1 or the device 2 needs to be adjusted to another interrupt number, so as to solve the interrupt conflict. When the device 1, the device 2, and the device 3 occupy the same interrupt number, it needs to ensure that one device uses an original interrupt number, and the interrupt numbers of another two devices are adjusted to other different interrupt numbers, so that the interrupt conflict may be solved.

In this embodiment, the first target external device refers to an interrupt conflict external devices that needs to be subjected to interrupt number adjustment, and the target interrupt number refers to an interrupt number in an idle state available for the interrupt conflict external devices.

It is to be noted that, the interrupt numbers are graded. In an interrupt transmission period, the interrupt number with higher priority corresponding to an earlier clock of the IRQ. For example, for the interrupt numbers IRQ2 and IRQ3, the IRQ corresponding to IRQ2 is transmitted to the PCH at a second clock, and the IRQ corresponding to IRQ3 is transmitted to the PCH at a third clock. Exemplary, to avoid a missing IRQ, priority of the target interrupt number further needs to be determined to be lower than priority of the current conflict interrupt number of the first target external device.

In an example, the target clock is determined through the following formula:

$$Δ T = ( m - n ) T ;$$

where ΔT is the target clock, m is number value of the target interrupt number, n is a number value of current conflict interrupt number, and T is a unit clock cycle.

In this embodiment, when the target interrupt number matching the first target external device is determined, a target clock to be waited is calculated according to a clock difference between the target interrupt number and the current conflict interrupt number of the first target external device. For example, the target interrupt number is IRQ10, the current conflict interrupt number is IRQ3, and the clock difference between IRQ10 and IRQ3 is 7, then the target clock is 7 clocks. Therefore, when the CPLD 20 receives the IRQ of the first target external device, the IRQ is transmitted to the PCH after waiting for 7 clocks, the PCH may receive the IRQ of the first target external device at a tenth clock, and the interrupt number of the first target external device identified by the PCH is IRQ10.

On the basis of the above embodiments, the operation that the first target external device of the interrupt conflict external devices and the target interrupt number matching the first target external device are determined includes the following operations.

When there are two interrupt conflict external devices, and there is at least one interrupt number in an idle state that meets a preset requirement, either of the interrupt conflict external devices is selected as the first target external device, and the target interrupt number matching the first target external device is determined from the interrupt number in the idle state.

The preset requirement is that priority of the interrupt number in the idle state is lower than priority of the current conflict interrupt number of the interrupt conflict external devices.

The interrupt number in the idle state is the interrupt number that is not configured for any external device.

In an example, when interrupt conflict devices include a device 1 and a device 2, and a current conflict interrupt number of the device 1 and the device 2 is IRQ3, the interrupt numbers in the idle state currently are determined first, for example, IRQ2, IRQ5, and IRQ10, then the interrupt numbers (that is, IRQ5 and IRQ10) in the idle state that meet a preset requirement are screened out, and then, the interrupt number of the device 1 may be adjusted to IRQ5 or IRQ10, or the interrupt number of the device 2 may be adjusted IRQ5 or IRQ10. This is not limited.

On the basis of the above embodiments, the operation that the target interrupt number matching the first target external device is determined from the interrupt number in the idle state includes the following operation.

The target interrupt number matching the first target external device is determined from the interrupt number in the idle state according to a preset proximity adjustment principle.

In an example, the preset proximity principle refers to that a clock difference between an adjusted target interrupt number and the current conflict interrupt number before adjusting is minimum.

For example, the current conflict interrupt number is IRQ3, the interrupt numbers in the idle state that meet the preset requirement are IRQ5 and IRQ10, it is obtained that the target clock corresponding to IRQ5 is 2 clocks according to a calculation formula of the target clock, and the target clock corresponding to the interrupt number IRQ10 is 7 clocks, then the interrupt number is IRQ5. In this way, response efficiency of the IRQ of the PCH is improved on the premise of ensuring that the interrupt numbers of the IRQ received by the PCH do not conflict.

In another example, the preset proximity principle may alternatively refer to that an interrupt number difference between an adjusted target interrupt number and the current conflict interrupt number before adjusting is minimum.

For example, the current conflict interrupt number is IRQ5, the interrupt numbers in the idle state that meet the preset requirement are IRQ7 and IRQ10, the interrupt number corresponding to the interrupt number IRQ7 is 2, and the interrupt number corresponding to the interrupt number IRQ10 is 5, then the target interrupt number is IRQ7. On the basis of the above embodiments, the operation that the first target external device of the interrupt conflict external devices and the target interrupt number matching the first target external device are determined includes the following operations.

Descending sorting is performed on the interrupt conflict external devices according to an importance score of the interrupt conflict external devices, and at least one target external device is selected from the interrupt conflict external devices according a descending sorting result when there are more than two interrupt conflict external devices, and there is at least one interrupt number in an idle state that meets a preset requirement.

The target interrupt number matching each first target external device is determined from interrupt number in the idle state.

The preset requirement is that priority of the interrupt number in the idle state is lower than priority of the current conflict interrupt number of the interrupt conflict external devices.

It is to be noted that, in this embodiment, an importance score of the interrupt conflict external devices is determined according to the priority of the current conflict interrupt number and an operating frequency of the interrupt conflict external devices.

In an example, the importance score Q is determined through the following formula:

Q=a*N+b*M, where N is a ranking of the interrupt conflict external devices after being subjected to the descending sorting according to the priority of the current conflict interrupt number, M is a ranking of the interrupt conflict external devices after being subjected to the descending sorting according to the operating frequency, and a and b are conventional coefficients.

It is to be noted that the importance score in this embodiment may alternatively be determined according to other impact factors. This is not limited.

In this embodiment, the priority of the target interrupt number corresponding to the first target external device is lower than the priority of the current conflict interrupt number corresponding to the first target external device, and a quantity of the interrupt numbers in the idle state that meet the preset requirement is less than a quantity of the interrupt conflict external devices that need to be subjected to interrupt number adjustment, so at least one first target external device is selected according to a descending sorting result to reduce an impact on server performance.

It may be understood that, the quantity of the interrupt conflict external devices that need to be subjected to interrupt number adjustment is determined according to a quantity of current conflict interrupt numbers and the quantity of the interrupt conflict external devices. For example, the interrupt conflict external devices include device 1, device 2, and device 3, the interrupt numbers of the device 1, the device 2, and the device 3 are all IRQ3 (that is, the current conflict interrupt number is IRQ3), then the quantity of the interrupt conflict external devices that need to be subjected to interrupt number adjustment is two.

In some embodiments, after the operation that the descending sorting is performed on the interrupt conflict external devices according to the importance score of the interrupt conflict external devices, the operation further includes the following operations.

At least one external device that needs to be disabled is selected from the interrupt conflict external devices according to the descending sorting result when a quantity of the interrupt numbers in the idle state that meets the preset requirement is less than a quantity of the interrupt conflict external devices that need to be subjected to interrupt number adjustment.

The quantity of the interrupt conflict external devices that need to be subjected to interrupt number adjustment is determined according to the quantity of the current conflict interrupt numbers and the quantity of the interrupt conflict external devices.

In this embodiment, to reduce the impact of an interrupt conflict on the server performance, after the descending sorting, whether the quantity of the interrupt numbers in the idle state that meets the preset requirement is less than the quantity of the interrupt conflict external devices that need to be subjected to interrupt number adjustment is determined, when the quantity of the interrupt numbers in the idle state that meets the preset requirement is less than the quantity of the interrupt conflict external devices that need to be subjected to interrupt number adjustment, the first target external device is selected according to the descending sorting result, and the interrupt conflict external devices that needs to be disabled is selected according to the descending sorting result.

For example, the interrupt number of the device 2 and the interrupt number of the device 4 are determined to be unchanged, and the device 1 and the device 5 are determined as first target external devices when the interrupt conflict external devices include a device 1, a device 2, a device 3, a device 4, and a device 5, the interrupt numbers of the device 1, the device 2, and the device 3 are all IRQ3, the interrupt numbers of the device 4 and the device 5 are both IRQ5, there are only two interrupt numbers in the idle state that meet the preset requirement, and the descending sorting result is that the device 2, the device 1, the device 3, the device 4, and the device 5. In addition, to ensure that the device 2 may be identified through IRQ3, the CPLD further sets the device 3 to disable IRQ3.

On the basis of the above embodiments, the operation that the target interrupt number matching the first target external device is determined from the interrupt number in the idle state includes the following operation.

The target interrupt number matching each first target external device is determined from the interrupt number in the idle state according to a preset proximity adjustment principle.

In an example, the preset proximity principle refers to that a clock difference between an adjusted target interrupt number and the current conflict interrupt number before adjusting is minimum.

For example, the current conflict interrupt number of the first target external device 1 is IRQ1, the current conflict interrupt number of the first target external device 2 is IRQ5, and the interrupt numbers in the idle state that meet the preset requirement are IRQ3, IRQ7, and IRQ10, the target interrupt number of the first target external device 1 is IRQ3, and the target interrupt number of the first target external device 2 is IRQ7. In this way, response efficiency of the IRQ of the PCH is improved on the premise of ensuring that the interrupt numbers of the IRQ received by the PCH do not conflict.

In another example, the preset proximity principle may alternatively refer to that an interrupt number difference between an adjusted target interrupt number and the current conflict interrupt number before adjusting is minimum. This is not limited herein.

An interrupt processing apparatus provided in this embodiment of the present disclosure is described below. The interrupt processing apparatus described below and the interrupt processing method described above may refer to each other.

The interrupt processing apparatus provided in this embodiment of the present disclosure includes a receiving module and a logic module.

The receiving module is configured to receive IRQs sent by external devices.

The logic module is configured to send the IRQs to a PCH based on preset control logic.

The preset control logic is used for controlling that interrupt numbers of the IRQ received by the PCH do not conflict.

According to the interrupt processing apparatus provided in this embodiment of the present disclosure, IRQs sent by external devices are received, and the IRQs are sent to a PCH based on preset control logic, where the preset control logic is used for controlling that interrupt numbers of the IRQs received by the PCH do not conflict. Therefore, the preset control logic of a CPLD realizes that the IRQs do not conflict.

In some embodiments, the logic module further includes an interrupt conflict detection unit and a first logic unit.

The interrupt conflict detection unit is configured to detect interrupt numbers configured for a plurality of external devices are detected, and determine the external devices with the same interrupt number as interrupt conflict external devices when the external devices with the same interrupt number are detected.

The first logic unit is configured to adjust the interrupt numbers of the IRQs of the interrupt conflict external devices received by a PCH based on preset control logic.

In some embodiments, the CPLD further includes a second logic unit.

The second logic unit is configured to send an IRQ of a second target external device to a PCH, where the second target external device is an external device other than the interrupt conflict external devices.

In some embodiments, the first logic unit includes a logic determination subunit and a logic control subunit.

The logic determination subunit is configured to determine a first target external device of interrupt conflict external devices and a target interrupt number matching the first target external device, where priority of the target interrupt number is lower than priority of a current conflict interrupt number of the first target external device.

The logic control subunit is configured to send an IRQ of the first target external device to the PCH after waiting for a target clock, so as to adjust the interrupt number of the IRQ of the first target external device from the current conflict interrupt number to the target interrupt number.

The target clock is determined based on the target interrupt number and the current conflict interrupt number.

In some embodiments, the target clock is determined through the following formula:

$$Δ T = ( m - n ) T ;$$

where ΔT is the target clock, m is number value of the target interrupt number, n is a number value of current conflict interrupt number, and T is a unit clock cycle.

In some embodiments, the logic determination subunit is further configured to select either of the interrupt conflict external devices as the first target external device when there are two interrupt conflict external devices, and there is at least one interrupt number in an idle state that meets a preset requirement, and determine the target interrupt number matching the first target external device from the interrupt number in the idle state.

The preset requirement is that priority of the interrupt number in the idle state is lower than priority of the current conflict interrupt number of the interrupt conflict external devices.

In some embodiments, the logic determination subunit is further configured to determine a target interrupt number matching a first target external device from the interrupt number in the idle state according to a preset proximity adjustment principle.

In some embodiments, the logic determination subunit is further configured to perform descending sorting performed on the interrupt conflict external devices according to an importance score of the interrupt conflict external devices, and select at least one target external device from the interrupt conflict external devices according a descending sorting result when there are more than two interrupt conflict external devices, and there is at least one interrupt number in an idle state that meets a preset requirement.

The logic determination subunit is further configured to determine an interrupt number matching each first target external device from the interrupt numbers in the idle state.

The preset requirement is that priority of the interrupt number in the idle state is lower than priority of the current conflict interrupt number of the interrupt conflict external devices.

In some embodiments, the logic determination subunit is further configured to determine a target interrupt number matching a first target external device from the interrupt number in the idle state according to a preset proximity adjustment principle.

In some embodiments, the preset proximity adjustment principle is that a clock difference between the target interrupt number and the current conflict interrupt number is minimum.

In some embodiments, the importance score is determined through the following formula:

$$Q = a * N + b * M ;$$

where Q is an importance score, N is a ranking of the interrupt conflict external devices after being subjected to the descending sorting according to the priority of the current conflict interrupt number, M is a ranking of the interrupt conflict external devices after being subjected to the descending sorting according to an operating frequency, and a and b are conventional coefficients.

In some embodiments, the logic determination subunit is further configured to select at least one external device that needs to be disabled from the interrupt conflict external devices according to the descending sorting result when a quantity of the interrupt numbers in the idle state that meets the preset requirement is less than a quantity of the interrupt conflict external devices that need to be subjected to interrupt number adjustment.

In some embodiments, the logic determination subunit is further configured to determine a target interrupt number matching each first target external device from the interrupt number in the idle state according to a preset proximity adjustment principle.

In some embodiments, the preset proximity adjustment principle is that a clock difference between the target interrupt number and the current conflict interrupt number is minimum.

An embodiment of the present disclosure further provides a server. The server includes a PCH 30 and a CPLD 20. The PCH 30 includes an interrupt input pin. As shown in FIG. 3, an input pin of the CPLD 20 is connected to an interrupt output pin of an external device 30, and an output pin of the CPLD 20 is connected to an interrupt input pin.

Exemplary, the CPLD 20 includes a plurality of pairs of input pins and output pins, and the PCH 10 includes a plurality of interrupt input pins.

The interrupt output pin of each external device 30 is connected to one of the interrupt input pins through one pair of input pin and output pin.

In this embodiment, the interrupt output pin of the external device 30 is connected to the input pin of the CPLD 20, the output pin of the CPLD 20 is connected to the interrupt input pin of the PCH 10, the PCH 10 assigns interrupt numbers for the IRQs of the external devices 30 according to the numbers of the pins, and the IRQs of the external devices 30 are transmitted to the CPLD 20 under clocks corresponding to the interrupt numbers assigned to the IRQs of the external devices, and are transmitted to the PCH 10 through the CPLD 20.

The CPLD 20 performs an interrupt processing method when executed. The method includes: IRQs sent by external devices are received, and the IRQs are sent to a PCH based on preset control logic, where the preset control logic is used for controlling that interrupt numbers of the IRQs received by the PCH do not conflict.

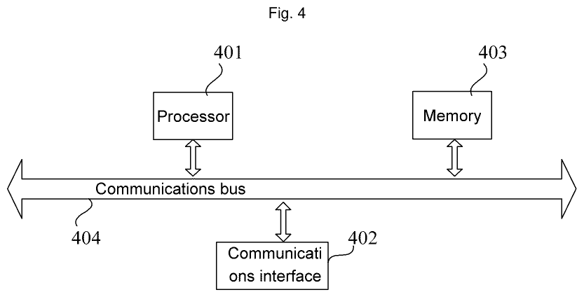

FIG. 4 is a schematic structural diagram of an electronic device provided in an embodiment of the present disclosure. As shown in FIG. 4, the electronic device may include: a processor 401, a communications interface 402, a memory 403, and a communications bus 404. The processor 401, the communications interface 402, and the memory 403 complete communication with each other through the communications bus 404. The processor 401 may invoke a logic instruction in the memory 403 to perform an interrupt processing method. The method includes: IRQs sent by external devices are received, and the IRQs are sent to a PCH based on preset control logic, where the preset control logic is used for controlling that interrupt numbers of the IRQs received by the PCH do not conflict.

In addition, the logic instruction in the foregoing memory 403 may be stored in a computer non-volatile readable storage medium when implemented in a form of a software functional unit and sold or used as a standalone product. Based on such understanding, a technical solution of the present disclosure essentially, or a part contributing to the related art, or all or part of the technical solutions may be manifested in a form of a software product. The computer software product is stored in a non-volatile readable storage medium, and includes a plurality of instructions for instructing a computer device (which may be a personal computer, a server, a network device, and the like) to execute all or part operations of the methods in various embodiments of the present disclosure. The foregoing volatile readable storage medium includes: various media that may store program codes, such as a USB Flash Drive, a mobile hard disk drive, a Read-Only Memory (ROM) a Random Access Memory (RAM), a magnetic disk, or an optical disk.

According to another aspect, the present disclosure further provides a computer program product. The computer program product includes a computer program stored on a non-transient computer non-volatile readable storage medium. The computer program includes a program instruction. When the program instruction is executed a computer, the computer may perform the interrupt processing method provided by various methods described above. The method includes: IRQs sent by external devices are received, and the IRQs are sent to a PCH based on preset control logic, where the preset control logic is used for controlling that interrupt numbers of the IRQs received by the PCH do not conflict.

According still another aspect, the present disclosure further provides a non-transient computer non-volatile readable storage medium, having a computer program stored therein. The computer program implements the interrupt processing method provided by various embodiments described above when executed by the processor. The method includes: IRQs sent by external devices are received, and the IRQs are sent to a PCH based on preset control logic, where the preset control logic is used for controlling that interrupt numbers of the IRQs received by the PCH do not conflict.

The apparatus embodiments described above are merely illustrative. The units described as separate components may or may not be physically separated, and the components displayed as units may or may not be physical units, that is, may be located in one place or distributed to a plurality of network units. Part or all of the modules may be selected according to actual needs to achieve the objective of the solution of this embodiment. Those of ordinary skill in the art may understand and implement without any creative effort.

Through the description of the above implementations, those of ordinary skill in the art may clearly understand that each implementation mode may be implemented by means of software plus a necessary general hardware platform, and of course, may also be implemented through hardware. Based on such understanding, the foregoing technical solutions essentially or the part contributing to the related art may be manifested in a form of a software product. The computer software product may be stored in a computer non-volatile readable storage medium, such as a ROM/RAM, a magnetic disk, or an optical disk, and includes several instructions to enable one computer device (which may be a personal computer, a server, a network device, and the like) to perform the methods described in various embodiments or some parts of the embodiments.

Finally, it is to be noted that: the above embodiments are only used for describing rather than limiting technical solutions of the present disclosure. Although the present disclosure has been described in detail with reference to the foregoing embodiments, those of ordinary skill in the art are to be understood that they may still modify the technical solutions recorded in the foregoing embodiments or equivalently replace some of the technical features thereof; and these modifications or replacements do not make the essence of the corresponding technical solutions deviate from the spirit and scope of the technical solutions of the various embodiments of the present disclosure.

1. An interrupt processing method, applied to a Complex Programmable Logic Device (CPLD), and comprising:
receiving Interrupt Requests (IRQs) sent by external devices; and
sending the IRQs to a Platform Controller Hub (PCH) based on preset control logic,
wherein the preset control logic is used for controlling that interrupt numbers of the IRQs received by the PCH do not conflict.

2. The interrupt processing method according to claim 1, wherein sending the IRQs to the PCH based on preset control logic comprises:
detecting the interrupt numbers configured for the external devices, and when external devices with a same interrupt number are detected, determining the external devices with the same interrupt number as interrupt conflict external devices; and
adjusting the interrupt number of the IRQs of the interrupt conflict external devices received by the PCH based on the preset control logic.

3. The interrupt processing method according to claim 2, wherein adjusting the interrupt number of the IRQs of the interrupt conflict external devices received by the PCH based on the preset control logic comprises:
determining a first target external device of the interrupt conflict external devices and a target interrupt number matching the first target external device, wherein priority of the target interrupt number is lower than priority of a current conflict interrupt number of the first target external device; and
sending an Interrupt Request (IRQ) of the first target external device to the PCH after waiting for a target clock, so as to adjust the interrupt number of the IRQ of the first target external device from the current conflict interrupt number to the target interrupt number,
wherein the target clock is determined based on the target interrupt number and the current conflict interrupt number.

4. The interrupt processing method according to claim 1, wherein sending the IRQs to the PCH based on preset control logic comprises:
determining an interrupt conflict external devices in the external devices;
determining a first target external device of the interrupt conflict external devices and a target interrupt number matching the first target external device, wherein priority of the target interrupt number is lower than priority of a current conflict interrupt number of the first target external device; and
by adjusting the target clock based on the preset control logic when the IRQ of the first target external device are sent to the PCH, adjust the interrupt numbers of the IRQ identified by the PCH, so as to control that the interrupt numbers of the IRQ received by the PCH do not conflict.

5. The interrupt processing method according to claim 3, wherein the target clock singer is determined through the following formula:
$$Δ T = ( m - n ) T ;$$
wherein ΔT is the target clock, m is a number value of the target interrupt number, n is a number value of the current conflict interrupt number, and T is a unit clock cycle.

6. The interrupt processing method according to claim 3, wherein determining the first target external device of the interrupt conflict external devices and the target interrupt number matching the first target external device comprises:
when there are two interrupt conflict external devices, and there is at least one interrupt number in an idle state that meets a preset requirement, selecting either of the interrupt conflict external devices as the first target external device, and determining the target interrupt number matching the first target external device from the interrupt number in the idle state,
wherein the preset requirement is that priority of the interrupt number in the idle state is lower than priority of the current conflict interrupt number of the interrupt conflict external devices.

7. The interrupt processing method of claim 6, wherein determining the target interrupt number matching the first target external device from the interrupt number in the idle state comprises:
determining the target interrupt number matching the first target external device from the interrupt number in the idle state according to a preset proximity adjustment principle.

8. The interrupt processing method according to claim 3, wherein determining the first target external device of the interrupt conflict external devices and the target interrupt number matching the first target external device comprises:
when there are more than two interrupt conflict external devices, and there is at least one interrupt number in an idle state that meets a preset requirement, performing descending sorting on the interrupt conflict external devices according to an importance score of the interrupt conflict external devices, and selecting at least one target external device from the interrupt conflict external devices according to a descending sorting result; and
determining the target interrupt number matching the first target external device from the interrupt numbers in the idle state,
wherein the preset requirement is that priority of the interrupt number in the idle state is lower than priority of the current conflict interrupt number of the interrupt conflict external devices.

9. The interrupt processing method according to claim 8, wherein the importance score is determined through the following formula:
$$Q = a * N + b * M ;$$
wherein Q is an importance score, N is a ranking of the interrupt conflict external devices after being subjected to the descending sorting according to the priority of the current conflict interrupt number, M is a ranking of the interrupt conflict external devices after being subjected to the descending sorting according to an operating frequency, and a and b are conventional coefficients.

10. The interrupt processing method according to claim 8, after performing descending sorting on the interrupt conflict external devices according to an importance score of the interrupt conflict external devices, further comprising:
when a quantity of the interrupt numbers in the idle state that meets the preset requirement is less than a quantity of the interrupt conflict external devices that need to be subjected to interrupt number adjustment, selecting at least one external device that needs to be disabled from the interrupt conflict external devices according to the descending sorting result,
wherein the quantity of the interrupt conflict external devices that need to be subjected to interrupt number adjustment is determined according to the quantity of the current conflict interrupt numbers and the quantity of the interrupt conflict external devices.

11. The interrupt processing method according to claim 10, wherein
the quantity of the interrupt conflict external devices that need to be subjected to interrupt number adjustment is equal to a difference between the quantity of the interrupt conflict external devices and the quantity of the current conflict interrupt numbers.

12. The interrupt processing method according to claim 10, wherein selecting at least one external device that needs to be disabled from the interrupt conflict external devices according to the descending sorting result comprises:
when the interrupt conflict external devices comprise a device 1, a device 2, a device 3, a device 4, and a device 5, the interrupt numbers of the device 1, the device 2, and the device 3 are all IRQ3, the interrupt numbers of the device 4 and the device 5 are both IRQ5, there are only two interrupt numbers in the idle state that meet the preset requirement, and the descending sorting result is that the device 2, the device 1, the device 3, the device 4, and the device 5, determining that the interrupt number of the device 2 and the interrupt number of the device 4 are unchanged, determining the device 1 and the device 5 as first target external devices, and setting the device 3 to disable IRQ3.

13. The interrupt processing method according to claim 8, wherein determining the target interrupt number matching the first target external device from the interrupt number in the idle state comprises:
determining the target interrupt number matching each first target external device from the interrupt number in the idle state according to a preset proximity adjustment principle.

14. The interrupt processing method according to claim 7, wherein the preset proximity adjustment principle is that a clock difference between the target interrupt number and the current conflict interrupt number is minimum.

15. The interrupt processing method according to claim 2, further comprising:
sending an IRQ of a second target external device to the PCH, wherein the second target external device is an external device other than the interrupt conflict external devices.

16. (canceled)

17. A server, comprising a Platform Controller Hub (PCH) and a Complex Programmable Logic Device (CPLD), wherein the PCH comprises an interrupt input pin;
an input pin of the CPLD is connected to an interrupt output pin of an external device, and an output pin of the CPLD is connected to the interrupt input pin; and
the CPLD implements operations comprising:
receiving Interrupt Requests (IRQs) sent by external devices; and
sending the IRQs to a Platform Controller Hub (PCH) based on preset control logic,
wherein the preset control logic is used for controlling that interrupt numbers of the IRQs received by the PCH do not conflict.

18. The server according to claim 17, wherein the CPLD comprises a plurality of pairs of input pins and output pins, and the PCH comprises a plurality of interrupt input pins, wherein
the interrupt output pin of each external device is connected to one of the interrupt input pins through one pair of input pin and output pin.

19. (canceled)

20. A non-transient computer non-volatile readable storage medium, having a computer program stored therein, wherein the computer program implements operations comprising:
receiving Interrupt Requests (IRQs) sent by external devices; and
sending the IRQs to a Platform Controller Hub (PCH) based on preset control logic,
wherein the preset control logic is used for controlling that interrupt numbers of the IRQs received by the PCH do not conflict.

21. The server according to claim 17, wherein the CPLD is a digital integrated circuit that allows a user to construct logic functions according to respective requirements, the CPLD is formed by a logic block, a programmable interconnect channel, and an Input/Output block (I/O block).

22. The server according to claim 1, wherein an input pin of the CPLD is connected to an interrupt output pin of an external device, and an output pin of the CPLD is connected to an interrupt input pin of the external device.
